(19) United States
(12) Patent Application Publication
(10) Pub. No.: US 2010/0235809 A1
(43) Pub. Date: Sep. 16, 2010

(54) SYSTEM AND METHOD FOR MANAGING A MODEL-BASED DESIGN LIFECYCLE

(75) Inventors: Manaswini Rath, Bangalore (IN); Kevin Uker, Tucson, AZ (US); Kumar Mahadevan, Hyderabad (IN); Krishan Kumar, Hyderabad (IN); Shobhit Shanker, Bangalore (IN); Lavanya Mallikarjuna, Hyderabad (IN); Soumya Nandavarapu, Hyderabad (IN); Aneel Kumar Reddy, Hyderabad (IN); Harish Gurram, Hyderabad (IN)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 12/403,295

(22) Filed: Mar. 12, 2009

(51) Int. Cl. G06F 3/048; G06F 9/44

(52) U.S. Cl. 717/105; 715/771

(57) ABSTRACT

Methods and systems are provided for managing a model-based design lifecycle having a plurality of stages. The system comprises an input interface for receiving input from the user of the system, a display device, and a processor coupled to the input interface and the display device. The processor is configured to display a user interface on the display device, wherein the user interface comprises a plurality of controls that each corresponds to a different process associated with a stage of the model-based design lifecycle. Certain ones of the controls are configured to require the user to perform the corresponding processes in a required order and certain other ones of the controls are arranged to encourage the user to perform the corresponding operation in a preferred order. The processor is also configured to retrieve a software module for each selected control to implement the corresponding process.

### TECHNICAL FIELD

The present invention generally relates to model-based design systems and methods, and more particularly to a system and method for managing a model-based design lifecycle.

### BACKGROUND

There is an ever-increasing demand for quick time-to-market and diverse functionalities for many vehicular products in the aircraft, watercraft, and automobile industries. As such, the traditional development process has, in many instances, been replaced with a model-based development process. When implementing this process, which is oftentimes referred to as “Model-based Development” (MBD), a designer develops one or more software models that simulate a target product of system.

Due to the complexities of modern vehicular products and the diverse functionalities that they include, it is common for many different designers or groups of designers to be involved in the development of the various software models for a target product or system. For example, in the case where the target product or system is a new vehicle, a first group of designers may develop software models for simulating the fuel system, a second group of designers may develop software models for simulating the steering system, and a third group of designers may develop software models for simulating the suspension system. Each group of designers may utilize various design strategies or techniques during the development of their respective software models. These varying design strategies and techniques may result in variability in the performance, portability, and/or stability in the software models, and the systems that they describe, for the new vehicle. Such variability can substantially impede the ability of process and quality engineers to maintain a consistent level of quality control over the development process for the target product or system.

Accordingly, it is desirable to provide a method for managing the development processes and strategies that are utilized during the development of software models for a target product or system using an MBD. Furthermore, other desirable features and characteristics of the present invention will become apparent from the subsequent detailed description of the invention and the appended claims, taken in conjunction with the accompanying drawings and this background of the invention.

### BRIEF SUMMARY

In one embodiment a system is provided for managing a model-based design lifecycle having a plurality of stages. The system comprises an input interface for receiving input from the user of the system, a display device, and a processor coupled to the input interface and the display device. The processor is configured to display a user interface on the display device, wherein the user interface comprises a plurality of controls that each corresponds to a different process associated with a stage of the model-based design lifecycle. Certain ones of the controls are configured to require the user to perform the corresponding processes in a required order and certain other ones of the controls are arranged to encourage the user to perform the corresponding operation in a preferred order. The processor is also configured to retrieve a software module for each selected control to implement the corresponding process.

In another embodiment, a method is provided for managing a model-based design lifecycle having a plurality of stages. The method comprises displaying a user interface on a display device, the user interface comprising a plurality of controls that each corresponds to a different process associated with a stage of the model-based design lifecycle. Certain ones of the controls are configured to require a user to perform the corresponding processes in a required order and certain other ones of the controls are configured to encourage the user to perform the corresponding processes in a preferred order. In addition, the method comprises retrieving a software module for each selected control in order to implement the corresponding process.

### BRIEF DESCRIPTION OF THE DRAWINGS

The present invention will hereinafter be described in conjunction with the following drawing figures, wherein like numerals denote like elements, and

FIG. 1 depicts a functional block diagram of an exemplary system that may be used to implement various processes described herein;

FIG. 2 is a block diagram of an exemplary Model-Based Design lifecycle;

FIG. 3 is a depiction of an exemplary requirement record that describes a requirement for a target product or system;

FIG. 4 is a depiction of an exemplary software model that includes a plurality of functional blocks for simulating a system that implements the requirement described by the requirement record of FIG. 3; and

FIG. 5 is a depiction of an exemplary user interface for managing the Model-Based Design lifecycle of FIG. 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

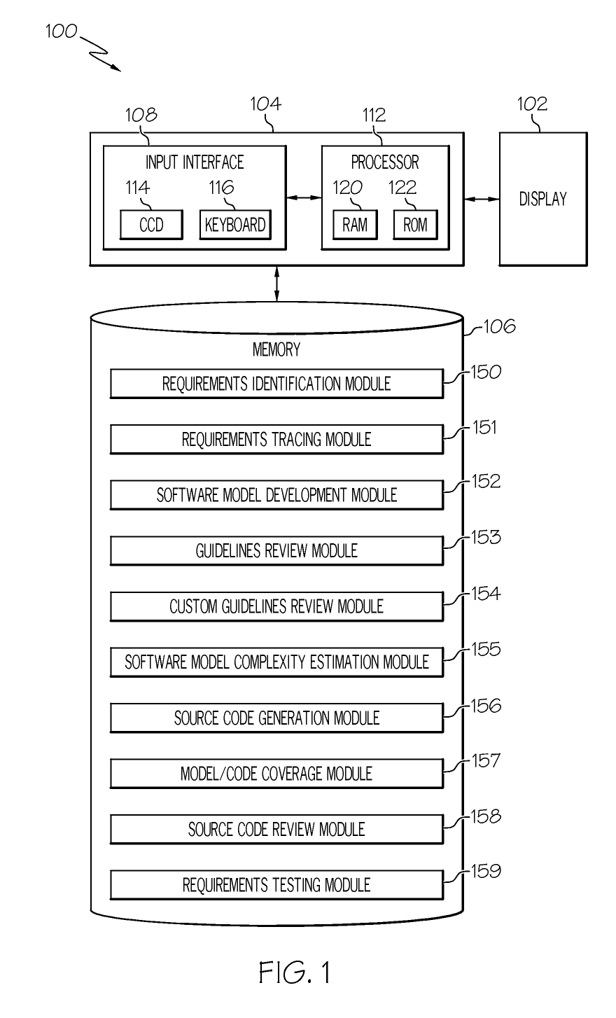

FIG. 1 is a functional block diagram of an exemplary system 100 that may be used to implement embodiments of the Model-Based Design lifecycle (hereinafter “MBD lifecycle”) described herein. In the depicted embodiment, the system 100 includes a display device 102, a processing system 104, and memory 106. The display device 102 is in operable communication with the processing system 104 and, in response to display commands received therefrom, displays various images. It will be appreciated that the display device 102 may be any one of numerous known displays suitable for rendering graphic, icon, and/or textual images in a format viewable by a user. Non-limiting examples of such displays include various cathode ray tube (CRT) displays, and various flat panel displays such as, for example, various types of LCD (liquid crystal display) and TFT (thin film transistor) displays. The display device 102 may additionally be based on a panel mounted display, a head up display (HUD) projection, or any known technology.

The processing system 104, at least in the depicted embodiment, includes an input interface 108 and a processor 112. The input interface 108 is in operable communication with the processor 112 and is configured to receive input from a user and, in response to the user input, supply various signals to the processor 112. The input interface 108 may be any one, or combination, of various known user interface devices including, but not limited to, a cursor control device (CCD), such as a mouse, a trackball, or joystick, and/or a keyboard, one or more buttons, switches, or knobs. In the depicted embodiment, the input interface 108 includes a CCD 114 and a keyboard 116. A user may use the CCD 114 to, among other things, move a cursor symbol over, and select, various items rendered on the display device 102, and may use the keyboard 116 to, among other things, input various data. A more detailed description of the why a user may select various rendered items with the CCD 114, and the various data that a user may input is provided further below.

The processor 112 is in operable communication with the memory 106, the display device 102, and the user interface 108 via one or more non-illustrated cables and/or busses. The processor 112 is configured to be responsive to user input supplied via the input interface 108 to, among other things, selectively retrieve data from memory 106, and to command the display device 102 to render various graphical, icon, and/or textual images. The processor 112 may include one or more microprocessors, each of which may be any one of numerous known general-purpose microprocessors or application specific processors that operate in response to program instructions. In the depicted embodiment, the processor 112 includes on-board RAM (random access memory) 120 and on-board ROM (read only memory) 122. The program instructions that control the processor 112 may be stored in either or both the RAM 120 and the ROM 122, or on a non-illustrated local hard drive. It will be appreciated that this is merely exemplary of one scheme for storing operating system software and software routines, and that various other storage schemes may be implemented. It will also be appreciated that the processor 112 may be implemented using various other circuits, not just one or more programmable processors. For example, digital logic circuits and analog signal processing circuits could also be used.

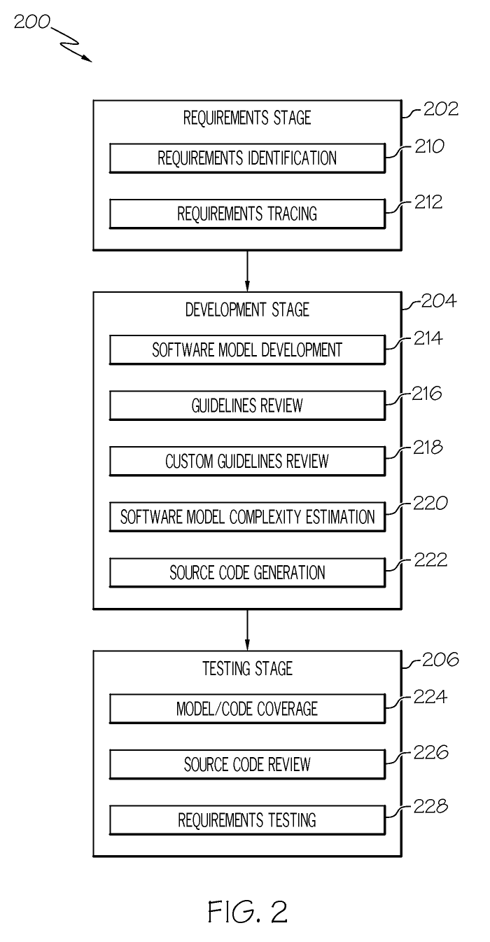

The memory 106, as noted above, is in operable communication with the processor 112. The memory 106 has various data stored thereon. These data include one or more libraries and/or software modules that may are used by processor 112 to implement processes associated with the MBD lifecycle described below (FIG. 2). For example the memory 106 may store a requirements identification module 150, a requirements tracing module 151, a software model generation module 152, a guidelines review module 153, a custom guidelines review module 154, a software model complexity estimation module 155, a source code generation module 156, a model/code coverage module 157, a source code review module 158, and a requirements testing module 159, to name a few. The library data may include a predetermined group of functional blocks that define various high-level functions as described below. Many of these software modules and libraries may be provided by one or more third-party software applications such as the Simulink® software tool used within the MATLAB® development environment. It will be appreciated that the memory 106 may be implemented using any one or more of numerous suitable devices for receiving and storing software modules, libraries, and/or other data. Some non-limiting examples include static memory, magnetic disks, hard drives, floppy drives, thumb drives, compact disks, and the like. In addition, the software modules and the library may, if needed or desired, be stored on separate memory devices or in separate sections of a common memory device. Moreover, the memory 106 may be disposed within the same structural casing as the processing system 104 and/or display device 102, or it may be disposed separately therefrom. It will additionally be appreciated that the processor 112 and memory 106 may be in operable communication via a local wired or wireless local area network connection or via a wide area network connection.

No matter the specific manner in which the display device 102, the processing system 104, and memory 106 are implemented and in operable communication, the processing system 104 is configured, generally in response to one or more user inputs to the user interface 108, to retrieve a software module from the memory 106. The processing system 104, implementing various software algorithms then performs the process associated with the retrieved software module.

FIG. 2 is a block diagram of an exemplary MBD lifecycle 200 for use with embodiments of the present invention. MBD lifecycle 200 includes stages and processes that can be implemented to encourage consistency in the design process of a target product or system. Thus, MBD lifecycle 200 may be utilized by process and quality engineer to enhance their ability to maintain a consistent level of quality control during the development process of a target product or system. The depicted MBD lifecycle 200 includes a requirements stage 202, a development stage 204, and a testing stage 206. Each of these stages 202, 204, 206 is associated with a plurality of processes. Embodiments of the present invention provide a user interface that is displayed on display device 102 (FIG. 1). This user interface includes a plurality of controls that correspond to these processes. The controls may be actuated by a user to cause processor 112 (FIG. 1) to retrieve and execute a software module for performing the corresponding process. As described below, certain ones of these controls are arranged to encourage the user to perform the associated processes in a preferred order. Further, certain other ones of these controls are configured to require the user to perform the corresponding processes in a required order.

Requirements stage 202 is the first stage of MBD lifecycle 200. During this stage 202 the requirements for the target product or system are identified. As further described below, these requirements will be linked to a software model for simulating the target product or system. The requirements stage 202 includes two processes, requirements identification 210 and requirements tracing 212.

Development stage 204 is the second stage of MBD lifecycle 200. During the development stage 204 a software model is generated for simulating the target product or model. The software model will support the requirements identified during requirements stage 202. In addition, the software model is analyzed to verify that it conforms to predetermined guidelines and to estimate its complexity. Finally, the software model is converted into source code for a predetermined programming language (e.g., the C programming language). The source code may be compiled into one or more executable formats and used for real-time simulation, prototyping, and/or embedded development of the target product or system. Development stage 204 includes five processes, software model development 214, guidelines review 216, custom guidelines review 218, software model complexity estimation 220, and source code generation 222.

Testing stage 206 is the final stage of MBD lifecycle 200. During the testing stage 206 the source code is analyzed to verify that it conforms to the software model. In addition, predetermined test vectors are applied to the software model and source code to determine if the support the requirements identified during requirements stage 202. Testing stage 206 includes three processes, model/code coverage 224, source code review 226, and requirements testing 228.

A description of each of the processes associated with MBD lifecycle 200, and their corresponding software modules will now be provided. Requirements identification 210 is associated with requirements stage 202. During this process 210, one or more designers identify requirements for the target product or system. For example, if the target product or system is a steering system for a new vehicle, the requirements may include a variable steering ratio and the ability to turn the wheel even when the vehicle is not moving. As described below, each of these requirements will be associated with a section or component of the software model that is designed to simulate the target product or system during development stage 204.

Requirements identification 210 may be implemented by a requirements identification module 150 (FIG. 1) that is retrieved and executed by processor 112 (FIG. 1) in response to one or more user inputs. In one embodiment, the requirements identification module enables the user to generate a requirement record for each identified requirement. Each requirement record describes the requirement and may be stored (e.g., in memory 106) and retrieved during subsequent stages of MBD lifecycle 200.

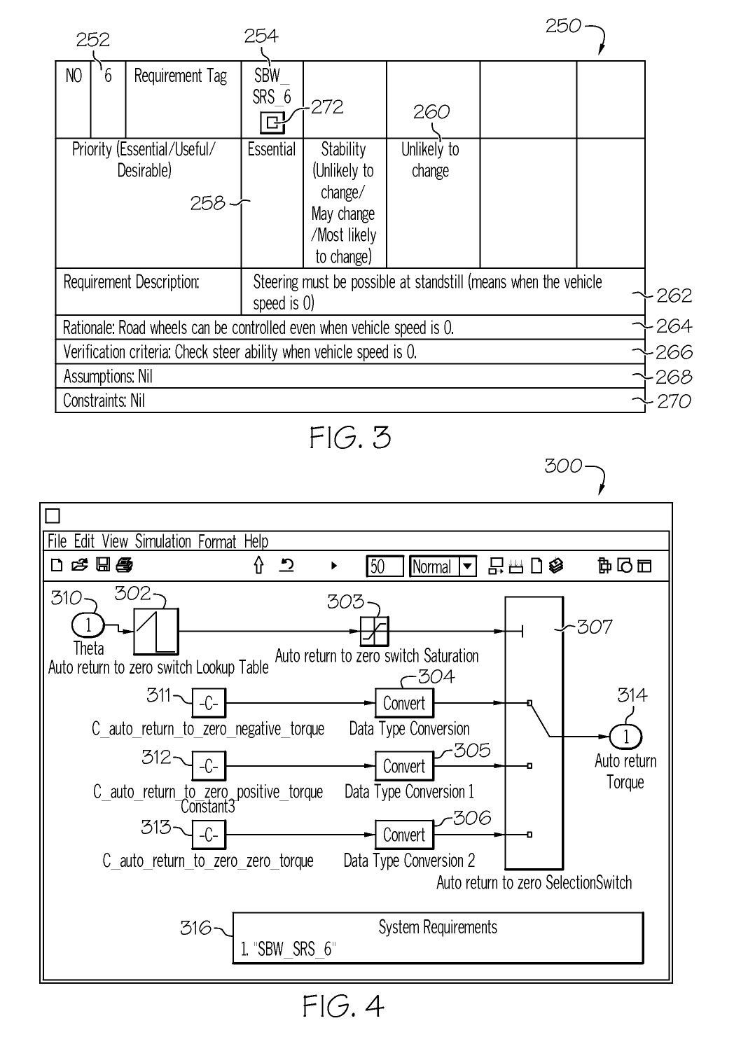

FIG. 3 is a depiction of an exemplary requirement record 250 that describes a requirement for the target product or system. Requirement record 250 includes a requirement number field 252, a requirement tag field 254, a priority field 258, a stability field 260, a description field 262, a rationale field 264, a verification criteria field 266, an assumptions field 268, and a constraints field 270. Each of these fields may be populated by the user to accurately describe the requirement in question.

Requirement number field 252 identifies a unique requirement number for requirement record 250. Requirement tag field 254 identifies a requirement tag that is used to generate a link 272 between requirement record 250 and a section of the software model described below. In one embodiment, link 272 comprises an embedded hyperlink that references the corresponding section or subsystem of the software model. The user activates link 272 to retrieve and view the corresponding section or subsystem of the software model. Priority field 258 describes the relative priority of the requirement (e.g., essential, useful, or desirable) and stability field 260 describes whether the requirement itself is likely to change. Further, description field 262, rationale field 264, and verification criteria field 266 respectively provide a textual description of the requirement, the rationale for the requirement, and the criteria for satisfying the requirement. Finally, assumption field 268 identifies any assumptions that should be made with respect to the requirement and constraints field 270 identifies the constraints for the requirement.

Returning to FIG. 2, requirements tracing 212 is also associated with requirements stage 202. During requirements tracing 212 the links (e.g., link 272 of FIG. 3) for each requirement record (e.g., requirement record 250 of FIG. 3) that is generated during requirements identification 210 are analyzed to verify that they correspond to a section or subsystem of the software model described below. Requirement records that are not linked to a section or subsystem of the software model may be identified, enabling the designers to verify that each identified requirement is addressed within the software model. Requirements tracing 212 may be implemented by a requirements tracing module 151 (FIG. 1) that is retrieved and executed by processor 112 (FIG. 1) in response to one or more user inputs.

Software model development 214 is the first process associated with development stage 204. During software model development 214, one or more designers develop a software model for simulating the identified requirements. The software model comprises a plurality of functional blocks that define high-level functions and may be arranged to generate a detailed block diagram of the target product or system. The software model is used to simulate the operation of the target product or system. Further, the software model may be segmented into one or more subsystems or other design components to simulate complex target models of systems.

FIG. 4 is a depiction of an exemplary software model 300 that includes a plurality of functional blocks for simulating a system that implements the requirement described by requirement record 250 (FIG. 3). Software model 300 may be generated by a software model development module 152 that is retrieved and executed by processor 112 (FIG. 1) in response to one or more user inputs. Software model 300 includes a plurality of functional blocks 302, 303, 304, 305, 306, 307, system inputs 310, 311, 312, 313, and a system output 314. These components are arranged in a functional block diagram for simulating a system that implements the requirement identified by requirement record 250 described above with regard to FIG. 3. It should be noted that software model 300 may be one of a plurality of subsystems that make up a larger software model (e.g., a software model that implements an entire steering system).

Software model 300 also includes a link 316 to requirement record 250 (FIG. 3). Link 316 may comprise an embedded hyperlink that references requirement record 250. The user activates link 316 to retrieve and view the requirement record 250. As described above, requirement record 250 also includes a link (e.g., link 272) that references software model 300 and that is verified during requirements tracing 212. These links are inserted by the user during software model development 214.

Functional blocks 302-307 may be selected from one or more functional block libraries. As described above, these functional block libraries may be stored in memory 106 (FIG. 1) and retrieved by processor 112 (FIG. 1). In one embodiment, the one or more functional block libraries may define a restricted set of functional blocks that are selected from a larger collection of functional blocks to encourage consistency in the development of the software model. For example, the Simulink® software tool includes a comprehensive set of libraries that provide a wide variety of functional blocks. This large variety of functional blocks enables the designers to utilize varying design strategies and techniques when designing the different sections and subsystems of a software model. As described above, such variability impedes the ability of process and quality control engineers to maintain consistent levels of quality control during the design and production of the target product or system.

The restricted set of functional blocks encourages the designers to utilize one or more desired design strategies or techniques, decreasing the variability in the resulting software model. The functional blocks within the restricted set may be selected based on the requirements identified during requirements stage 202. In addition, the restricted set of functional blocks may comprise functional blocks that provide high-level functions known to be useful for the industry or technology associated with the target product or system. In one embodiment at least a portion of the functional blocks in the restricted group are chosen from functional blocks available in one or more libraries provided by the Simulink® software tool.

Returning to FIG. 2, guidelines review 216 is associated with development stage 204. This process 216 may be implemented by a guidelines review module 153 (FIG. 1) that is retrieved and executed by processor 112 (FIG. 1) in response to one or more user inputs. During the guidelines review 216, the software model (or a subsystem of the software model) is analyzed to identify conditions and configuration settings that may result in inaccurate or inefficient simulation of the target product or system and/or model settings that can result in the generation of inefficient source code. The guidelines review module 153 (FIG. 1) may enable the user to select guidelines provided by the Simulink® software tool. It may also generate a report identifying suboptimal conditions or settings and suggesting better software model configurations where appropriate.

Custom guidelines review 218 is also associated with development stage 204. This process 218 may be implemented by a custom guidelines review module 154 (FIG. 1) that is retrieved and executed by processor 112 (FIG. 1) in response to one or more user inputs. During custom guideline review 218, the software model (or a subsystem of the software model) is analyzed to determine if it complies with predetermined custom guidelines. The custom guidelines help ensure consistency in the design of the software model and the corresponding source code. For example, the custom guidelines may state that the names for all functional block inputs should end with “in” and the names for all functional block outputs should end with “out.” The custom guideline review module 154 (FIG. 1) analyzes the software model (or one of its subsystems) and generates a report identifying the functional blocks or subsystems that do not conform to the custom guidelines.

In addition, software model complexity estimation 220 is associated with development stage 204. This process 220 may be implemented by a software complexity estimation module 155 (FIG. 1) that is retrieved and executed by processor 112 (FIG. 1) in response to one or more user inputs. During software model complexity estimation 220, the complexity of the software model (or a subsystem of the software model) is estimated. The complexity off the software model may be estimated using a plurality of methods. For example, in one embodiment the software model estimation module may identify the amount of time required to set predetermined properties within the software model that enable it to be converted into source code during source code during source code generation 222. In general, the time required to set these software properties will increase as the complexity of the software model increases.

Source code generation 222 is the final process associated with development stage 204. This process 222 may be implemented by a source code generation module 156 (FIG. 1) that is retrieved and executed by processor 112 (FIG. 1) in response to one or more user inputs. During source code generation 222, the software model (or a subsystem of the software model) is converted into source code for a predetermined programming language, such as C programming language. The source code is generated based on predetermined software settings, configurations, and templates associated with the software model and the functional blocks used therein. As stated above, the source code may be compiled into one or more executable formats and used for real-time simulation, prototyping, and or embedded development of the target product or system.

Model/code coverage 224 is associated with testing stage 206. This process 224 may be implemented by a model/code coverage module 157 (FIG. 1) that is retrieved and executed by processor 112 (FIG. 1) in response to one or more user inputs. During model/code coverage 224 predetermined test vectors are applied to the software model (or a subsystem of the software model) and/or the corresponding source code. Elements of the software model or source code that are not covered by these test vectors are identified. The test vectors may be selected based on the requirements identified during requirements stage 202. The designer may identify additional test vectors to address the uncovered elements of the software model or source code or the user may determine that the uncovered elements are not necessary.

Source code review 226 is also associated with testing stage 206. This process 226 may be implemented by a source code review module 158 (FIG. 1) that is retrieved and executed by processor 112 (FIG. 1) in response to one or more user inputs. During source code review 226, the logic and conditions utilized in the software model are compared with the logic and conditions of the corresponding source code. For example, the software model (or a subsystem of the software module) may be analyzed to identify source code templates that correspond to functional blocks utilized therein. The corresponding section of source code is then analyzed to verify that it conforms to the identified source code templates. In addition, the data and control flow of the source code may be analyzed to ensure that it matches the data and control flow of the software model. A report may be generated identifying sections of the model that cannot be verified against the model.

Requirements testing 228 is the final process of testing stage 206. This process 228 may be implemented by a requirements testing module 159 (FIG. 1) that that is retrieved and executed by processor 112 (FIG. 1) in response to one or more user inputs. During requirements testing 228 predetermined test vectors are applied to the source code to determine that it supports the identified requirements. The predetermined test vectors may be selected by the designer to verify that each of the requirements identified during requirements stage 202 is supported. In addition, any new test vectors generated during model/code coverage may also be utilized. Requirements testing 228 may also determine performance, reliability, and or any other testing metrics that are useful to the designer.

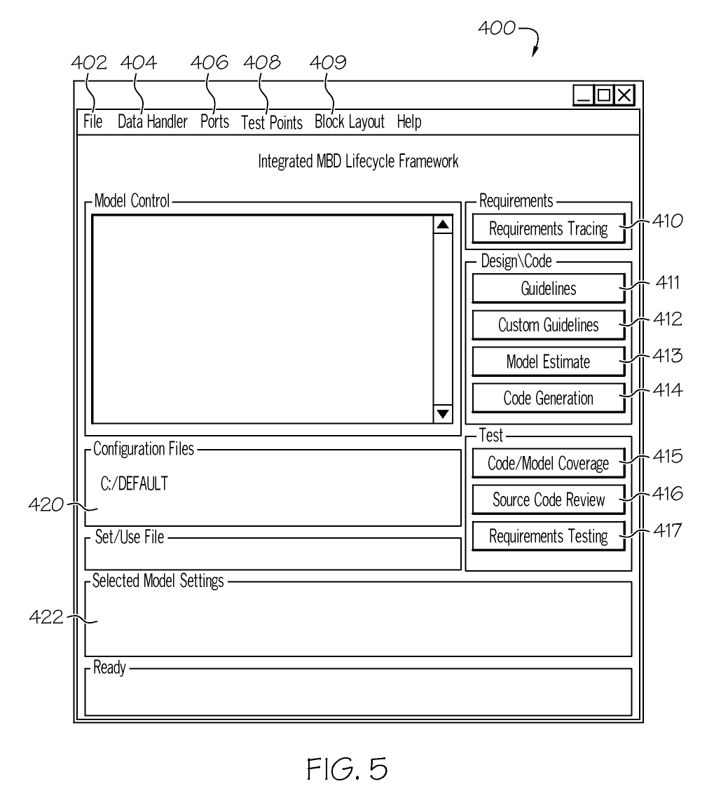

FIG. 5 is a depiction of an exemplary user interface 400 for managing an MBD lifecycle (e.g., MBD lifecycle 200 of FIG. 2). User interface 400 integrates the processes 210, 212, 214, 216, 218, 220, 222, 224, 226, 228 (FIG. 2) of the MBD lifecycle into a single interface. As described below, user interface 400 is configured to compel the user (e.g., a designer of the target product or system) to perform each of these processes to enhance the ability or process and quality engineers to maintain a consistent level of quality control over the development process. User interface 400 is configured to encourage the user to perform certain processes in preferred order and to require the user to perform certain processes in a required order. User interface 400 may be displayed on display device 102 (FIG. 1) by processor 112 (FIG. 1) in response to one or more user inputs. In one embodiment, user interface 400 is integrated with one or more software systems, such as the Simulink® software tool. These software systems may be configured to provide one or more of the software modules described herein.

User interface 400 manages the MBD lifecycle via a plurality of selectable menu items and controls. As depicted, user interface 400 includes a file menu item 402, a data handler menu item 404, a ports menu item 406, a test points menu item 408, and a block layout menu item 402. In one embodiment file menu item 402 enables the user to identify the location (e.g., in memory 106 of FIG. 1) where a project file is stored. With reference to FIGS. 2 and 5, the project file is associated with a plurality of requirement records generated during requirements identification 210 and a software model developed during software model development 214. This project file may be generated by an MBD development environment that causes processor 112 (FIG. 1) to retrieve and execute the requirements identification module 150 and the software model development module 152. This development environment may be provided by a separate software system, such as the Simulink® software tool.

The data handler menu item 404 causes processor 112 (FIG. 1) to retrieve and execute a software module that allows the software model to access or provide data or signals to software models running on other electronic devices or platforms during simulation. The ports menu item 406 enables the user to identify and configure one or more input/output ports that may be used to receive and transmit the data between the software model in question and the other software models. The test points menu item 408 enables the user to identify a location (e.g., in memory 106 of FIG. 1) where one or more test vectors are stored for testing the software model and corresponding source code. Finally, the block layout menu item 409 enables the user to edit the software model to address any issued identified during MBD lifecycle 200.

In addition, user interface 400 includes a requirements tracing control 410, a guidelines control 411, a custom guidelines control 412, a model estimate control 413, a code generation control 414, a code/model coverage control 415, a source code review control 416, and a requirements testing control 417. Each of these controls 410-417 corresponds to a process associated with MBD lifecycle 200. In the depicted embodiment controls, controls 410-417 comprise selectable buttons. However, it will be understood by one who is skilled in the art that controls 410-417 may comprise any selectable software control.

Requirements trace control 410 causes processor 112 (FIG. 1) to retrieve and execute requirements tracing module 151 (FIG. 1). Guidelines control 411 causes processor 112 (FIG. 1) to retrieve and execute guidelines review module 153 (FIG. 1). Custom guidelines control 412 causes processor 112 (FIG. 1) to retrieve and execute custom guidelines review module 154 (FIG. 1). Model estimate control 413 causes processor 112 (FIG. 1) to retrieve and execute the software model complexity estimation module 155 (FIG. 1). Code generation control 414 causes processor 112 (FIG. 1) to retrieve and execute the source code generation module 156 (FIG. 1). Model/code coverage control 415 causes processor to retrieve and execute the model/code coverage module 157. Source code review control 416 causes processor 112 (FIG. 1) to retrieve and execute the source code review module 158. Finally, requirements testing control 417 causes processor 112 (FIG. 1) to retrieve and execute the requirements testing module 159.

In addition, user interface 400 may also include additional fields for providing information that is useful during MBD lifecycle 200. For example, user interface 400 may provide a configuration files field 420 for identifying the location where the configuration settings for the software model are stored (e.g., in memory 106 of FIG. 1) and a model settings field 422 for identifying any model settings for the software model.

User interface 400 requires the user to perform requirements identification 210 and software model development 214 before performing the other processes associated with MBD lifecycle 200. For example, in one embodiment controls 410-417 are disabled until the user selects file menu item 402 to designate the stored location of a project file corresponding to a desired set of requirement records and a software model. It should be noted that other methods of requiring the user to perform requirements identification 210 and software model development 214 before performing the other processes may also be utilized. For example, as described above user interface 400 may be integrated with a software system, such as the Simulink® software tool, that provides a development environment that allows the user to launch user interface 400 only after processes 210 and 214 are performed.

After requirements identification 210 and software model development 214 have been performed, user interface 400 allows the user to perform additional processes. In one embodiment, user interface 400 encourages the user to perform requirements tracing 212, guidelines review 216, custom guidelines review 218, and software model complexity estimation 220 in a preferred order. For example, user interface 400 may enable the requirements tracing control 410, guidelines control 411, custom guidelines control 412, and model estimate control 413 after requirements identification 210 and software model development 214 have been performed. As depicted, controls 410-413 are positioned in a preferred order (e.g., from top to bottom). This arrangement encourages the user to perform the processes that correspond to controls 410-413 in the same preferred order (e.g., requirements tracing 212 first, guidelines review 216 second, custom guidelines review 218 third, and software model complexity estimation 220 fourth). It should be noted that other arrangements and configurations of controls 410-413 controls may also be utilized to encourage the user to perform processes 212, 216, 218 and 220 in the preferred order.

Alternatively, user interface 400 may require the user select controls 410-413 in a required order. For example, user interface 400 may enable only control 410, requiring the user to perform requirements tracing 212 before performing processes 216, 218, or 220. After the user completes requirements tracing 212, user interface could then enable control 411, requiring the user to perform guidelines review 216 before performing processes 218 or 220. This process would continue until each of processes 212, 216, 218, and 220 are performed in the required order.

After the user performs requirements tracing 212, guidelines review 216, custom guidelines review 218, and model complexity estimation 224 (e.g., by selecting controls 410-413), user interface 400 allows the user to perform source code generation 222. To accomplish this, user interface 400 enables code generation control 414. It should be noted that processes 212, 216, 218, and 220 each encourage the designers of the target product or system to utilize consistent design strategies and techniques during the development process. Thus, by requiring the user to implement these processes before generating source code for a software model, user interface 400 enhances the ability of process and quality engineers to maintain a consistent level of quality control during the development process.

After source code generation 222 is performed, user interface 400 enables the user to perform model/code coverage 224, source code review 226, and/or requirements testing 228. To accomplish this, user interface 400 enables model/code coverage control 415, source code review control 416, and/or requirements testing control 417. In one embodiment user interface 400 enables all three controls 415-417. As depicted, controls 415-417 are positioned in a preferred order (e.g., from top to bottom). This arrangement encourages the user to perform the corresponding processes in the same preferred order (e.g., model/code coverage 224 first, source code review 226 second, and requirements testing 228 third).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for managing a model-based design lifecycle having a plurality of stages, the system comprising:
an input interface for receiving input from the user of the system;
a display device; and
a processor coupled to the input interface and the display device, and configured to:
display a user interface on the display device, the user interface comprising a plurality of controls that each corresponds to a different process associated with a stage of the model-based design lifecycle, wherein certain ones of the controls are configured to require the user to perform the corresponding processes in a required order; and
retrieve a software module for each selected control to implement the corresponding process.

2. The system of claim 1, wherein certain other ones of the controls are arranged to encourage the user to perform the corresponding processes in a preferred order.

3. The system of claim 2, wherein the plurality of stages comprises a requirements stage, a development stage, and a testing stage.

4. The system of claim 1, wherein a requirements identification process and a software model development process are each associated with a stage of the model-based design lifecycle and the processor is further configured to require the user to perform the requirements identification process and the software model development process before selecting one of the plurality of controls.

5. The system of claim 4, wherein the software model development process comprises generating a software model utilizing a restricted set of functional block diagrams.

6. The system of claim 1, wherein a guidelines review process and a source code generation process are each associated with a stage of the model-based design lifecycle and the processor is further configured to:
display a first control associated with the guidelines review process and a second control associated with the source code generation process, wherein the second control is configured to require the user to select the first control prior to selecting the second control.

7. The system of claim 6, wherein a requirements testing process is associated with a stage of the model-based design lifecycle and the processor is further configured to:
display a third control associated with the requirements testing process, wherein the third control is configured to require the user to select the second control prior to selecting the third control.

8. The system of claim 2, wherein a guidelines review process and a custom guidelines review process are each associated with a stage of the model-based design lifecycle and the processor is further configured to:
display a first control associated with the guidelines review process and a second control associated with the custom guidelines review process, wherein the first control and the second control are positioned to encourage the user to select the first control before selecting the second control.

9. The system of claim 8, wherein a source code generation process is associated with a stage of the model-based design lifecycle and the processor is further configured to:
display a third control associated with the source code generation process, wherein the third control is configured to require the user to select the first control and the second control prior to selecting the third control.

10. The system of claim 9, wherein a model/code coverage process and a requirements testing process are each associated with a stage of the model-based design lifecycle and the processor is further configured to:
display a fourth control associated with the model/code coverage process and a fifth control associated with the requirements testing process, wherein the fourth control and the fifth control are configured to require the user to select the third control prior to selecting the fourth control or the fifth control.

11. A method for managing a model-based design lifecycle having a plurality of stages, the method comprising:
displaying a user interface on a display device, the user interface comprising a plurality of controls that each corresponds to a different process associated with a stage of the model-based design lifecycle, wherein certain ones of the controls are configured to require a user to perform the corresponding processes in a required order and certain other ones of the controls are configured to encourage the user to perform the corresponding processes in a preferred order; and
retrieving a software module for each selected control in order to implement the corresponding process.

12. The method of claim 11, wherein the step of displaying further comprises displaying the user interface on the display device comprising a plurality of controls that are each associated with the model-based design lifecycle comprising a requirements stage, a development stage, and a testing stage.

13. The method of claim 12, wherein the requirements stage further comprises a requirements identification process and the development stage further comprises a software model development process and the method further comprises requiring the user to perform the requirements identification process and the software model development process before selecting one of the plurality of controls.

14. The method of claim 13, wherein the development stage further comprises a guidelines review process, a custom guidelines review process, and a software model complexity estimation process, and the step of displaying further comprises:
displaying a first control corresponding to the guidelines review process;
displaying a second control corresponding to the custom guidelines review process; and
displaying a third control corresponding to the software model complexity estimation process, wherein the first control, the second control, and the third control are positioned on the user interface to encourage the user to select them in a preferred order.

15. The method of claim 14, wherein the development stage is further associated with a source code generation process and the step of displaying further comprises:
displaying a fourth control corresponding to the source code generation process and configured to require the user to select the first control, the second control, and the third control prior to selecting the fourth control.

16. The method of claim 15, wherein the testing stage comprises a model/code coverage process and a requirements testing process and the step of displaying further comprises:
displaying a fifth control corresponding to the model/code coverage process, wherein the fifth control may be selected after the fourth control is selected; and
displaying a sixth control corresponding to the requirements testing process, wherein:
the sixth control may be selected after the fourth control is selected; and
the fifth control and the sixth control are positioned on the user interface to encourage the user to select them in a preferred order.

17. A computer readable medium having instructions stored thereon that when executed by a processor cause the processor to perform a method for managing a model-based design lifecycle having a requirements stage, a development stage, and a testing stage, the method comprising:
displaying a user interface on a display device, the user interface comprising a plurality of controls that each corresponds to a different process associated with the requirements stage, the development stage, or the testing stage, wherein certain ones of the controls are configured to require a user to perform the corresponding processes in a required order and certain other ones of the controls are configured to encourage the user to perform the corresponding processes in a preferred order; and
retrieving a software module for each selected control to implement the corresponding process.

18. The computer readable medium of claim 17, wherein the requirements stage comprises a requirements identification process and the development stage comprises a software model development process and the method further comprises requiring the user to perform the requirements identification process and the software model development process before selecting one of the plurality of controls.

19. The computer readable medium of claim 18, wherein the requirements stage further comprises a requirements tracing process, the development stage further comprises a guidelines review process, a custom guidelines review process, a software model complexity estimation process, and a source code generation process, and the step of displaying further comprises:
displaying a first control corresponding to the requirements tracing process;
displaying a second control corresponding to the guidelines review process;
displaying a third control corresponding to the custom guidelines review process;
displaying a fourth control corresponding to the software model complexity estimation process, wherein the first control, the second control, the third control, and the fourth control are positioned on the user interface to encourages the user to select them in a preferred order, and
displaying a fifth control corresponding to the source code generation process, wherein the user is required to select the first control, the second control, the third control, and the fourth control prior to selecting the fifth control.

20. The computer readable medium of claim 19, wherein the testing stage comprises a model/code coverage process, a source code review process, and a requirements testing process, and the step of displaying further comprises:
displaying a sixth control corresponding to the model/code coverage process, wherein the sixth control may be selected after the fifth control has been selected;
displaying a seventh control corresponding to the source code review process, wherein the seventh control may be selected after the fifth control has been selected; and
displaying an eighth control corresponding to the requirements testing process, wherein:
the eighth control may be selected after the fifth control has been selected; and
the sixth control, the seventh control, and the eighth control are positioned on the user interface to encourage the user to select them in a preferred order.
